(19) United States
(12) Patent Application Publication
(10) Pub. No.: US 2026/0231272 A1
(43) Pub. Date: Aug. 6, 2026

(54) METHOD AND APPARATUS FOR BUFFERED DATA DELAY REPORTING IN A WIRELESS COMMUNICATION SYSTEM

(71) Applicant: SAMSUNG ELECTRONICS CO., LTD., Suwon-si, Gyeonggi-do (KR)

(72) Inventors: Vinay Kumar SHRIVASTAVA, Bangalore (IN); Sriganesh RAJENDRAN, Bangalore (IN); Aby Kanneath ABRAHAM, Bangalore (IN)

(21) Appl. No.: 19/154,315

(22) PCT Filed: Feb. 8, 2024
(86) PCT No.: PCT/KR2024/001934

§ 371 Date: Aug. 6, 2025

(30) Foreign Application Priority Data
Feb. 8, 2023 (IN) 202341008206
Jan. 23, 2024 (IN) 202341008206

(51) Int. Cl. H04W 76/20; H04W 28/06; H04W 80/02

(52) U.S. Cl. CPC H04W 76/20; H04W 28/06; H04W 80/02

(57) ABSTRACT

The disclosure relates to a 5G or 6G communication system for supporting a higher data transmission rate. Embodiments herein disclose methods for handling a buffered data delay reporting for an XR service in a wireless network (300) by a UE (100). The method includes determining and composing the buffered data delay reporting including a delay information field for the XR service. The delay information field is included in a MAC CE, and the delay information field is associated with a corresponding buffer data size field included in the MAC CE, and the MAC CE pertains to the XR service. Further, the method includes sending the buffered data delay reporting to a network entity (200). The proposed method can be used for providing an efficient buffered data delay reporting for extended reality in the wireless networks with improved user experience.

### TECHNICAL FIELD

Embodiments disclosed herein relate to wireless networks, and more specifically related to a method and a User Equipment (UE) for handling buffered data delay reporting for extended reality in the wireless networks.

### BACKGROUND ART

5G (5th Generation) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Extended Reality (XR) is an umbrella term for different realities including Virtual Reality (VR), Augmented Reality (AR) and Mixed Reality (MR), and is considered as an essential technology to enable the realization of digital twin/meta universe. The XR is incorporated as an agreed work item in fifth generation (5G) Advanced (i.e., 3GPP Release 18), which is targeted to provide a communication system framework that fulfills challenging needs of high data rate, very low latency and power efficient connectivity for the XR applications.

Protocol Data Convergence Protocol (PDCP), Radio Link Control (RLC) and Medium Access Control (MAC) are layer-2 sub-layers and are involved in a number of functionalities for the data plane processing of transmitted packets and received packets. Buffer Status Report (BSR) reporting procedure involves sending of the buffered data status (e.g., size of the buffered data) across different Logical channel Groups (LCGs). This facilities the scheduling operation of a network entity. That is, the network entity can allocate uplink grants to the UE in order to serve the buffered data at the UE. However, there is no information on the delay status of the buffered data. In general, the buffered data may have different delay status as the data storage at the buffer may have happen at different points in time. Moreover, the different services have different packet delay budget which implies the buffered data (i.e., a packet or a Service Data Unit (SDU)) is subject to discard when it overshoots the packet delay budget limit, or any associated limit configured. The SDU discard procedure involves discard of the PDCP SDU when the associated timer is expired or the successful delivery of a PDCP SDU is confirmed from a peer PDCP entity, (for example) through a PDCP status report.

For the XR applications, the existing buffer status reporting may not be efficient and effective as the XR application may be extremely delay sensitive and require low latency of performance. As a result, existing mechanism may lead to an in-efficient scheduling and/or excessive packet discard, if applied to XR applications.

Thus, it is desired to address the above mentioned disadvantages or other shortcomings or at least provide a method and system for buffered data delay reporting for extended reality in the wireless networks.

### DISCLOSURE OF INVENTION

### Technical Problem

The principal object of the embodiments herein is to disclose methods and a UE for managing buffered data delay reporting for extended reality in wireless networks.

Another object of the embodiment herein is to determine and compose (or prepare) the buffered data delay reporting including delay information field and buffer data size field for a XR service in the wireless networks.

Another object of the embodiment herein is to send the buffered data delay report including the delay information field and the buffer data size field for a XR service in the wireless networks.

Another object of the embodiment herein is to schedule by a network entity for the different buffered data for the UE based on the corresponding delay information reported.

### Solution to Problem

Accordingly, the embodiments herein provide a method for handling a buffered data delay reporting for an extended reality (XR) service in a wireless network. The method includes determining and composing (or preparing), by a UE, the buffered data delay reporting including a delay information field for the XR service. The delay information field is included in a MAC Control Element (CE), and the delay information field is associated with a corresponding buffer data size field included in the MAC CE, and the MAC CE pertains to the XR service. Further, the method includes sending, by the UE, the buffered data delay reporting to a network entity.

In an embodiment, the delay information field for a buffered data and the buffer data size field corresponds to a Logical Channel Group (LCG) from a plurality of LCGs. The MAC CE is a Delay Status Report (DSR) MAC CE.

In an embodiment, the delay information field and the buffer data size field for each configured LCG are included in the DSR MAC CE.

In an embodiment, the delay information field corresponds to the buffer data size field included for a LCG in the DSR MAC CE, where each of the buffer data size field is included along with the delay information field.

In an embodiment, the delay information field for the buffered data is quantized in a uniform manner to derive mapping indices that represent a value for a delay associated with the XR service.

In an embodiment, the DSR MAC CE for the XR service is identified by an extended Logical Channel Identity (eLCID), where the eLCID for identifying the DSR MAC CE is one octet in size.

In an embodiment, a separate field including a single bit is used to indicate a presence or absence of a delay information field and buffer data size field for the LCG in a content associated with the buffered data delay reporting, where the delay information field and the buffer data size field are available for the LCG in the content associated with the buffered data delay reporting when a value of field is set for one for the LCG.

In an embodiment, a distinct field including a single bit is used to indicate a presence or absence of the delay information field and the buffer data size field for the LCG in a content associated with the buffered data delay reporting, where the delay information field and the buffer data size field are not available for the LCG in the content associated with the buffered data delay reporting, when the value of field is zero for the LCG.

In an embodiment, the delay information field for the LCG is configured by the network entity for sending the delay information field, where a configuration of the logical channel group is received from the network entity in a radio resource control (RRC) reconfiguration message.

In an embodiment, the delay information field and the buffer data size field are included in an order of the priority of the LCG.

In an embodiment, the method includes sending a delay information field in a UL MAC CE using six bits which includes a value for an actual delay, where the delay information field indicates remaining time for a pertinent discard timer expiry.

In an embodiment, the DSR MAC CE is triggered when a delay of a packet or a PDU or a PDU Set or a SDU or remaining time for a discard timer expiry meets a threshold, where the threshold is configured per logical channel group.

In an embodiment, the DSR MAC CE is triggered when the UE is configured by the network entity to trigger the DSR MAC CE, where the DSR MAC CE is triggered when there is an event for one or more specific logical channel groups configured by the network entity for sending the DSR MAC CE.

In an embodiment, a MAC PDU includes at most one BSR MAC CE and/or at most one DSR MAC CE, when multiple events have triggered a BSR and/or a DSR and the BSR is separately signalled as different MAC CEs for a XR service and a non-XR service (i.e. XR BSR MAC CE and BSR MAC CE).

In an embodiment, a MAC entity of the UE performs a Multiplexing and Assembly procedure to generate the DSR MAC CE or XR BSR MAC CE, when a buffer status reporting procedure determines that an DSR or XR BSR has been triggered and not cancelled and a UL-SCH resources are available for a transmission and the UL-SCH resources accommodates the DSR MAC CE or XR BSR MAC CE plus its subheader as a result of logical channel prioritization.

In an embodiment, the buffered data delay reporting is cancelled when the XR service becomes unavailable due to a SDU or a PDU set discard upon a discard timer expiry or loss of a packet.

In an embodiment, the buffered data delay reporting triggered prior to MAC PDU assembly is cancelled when a MAC PDU is transmitted.

In an embodiment, a RLC entity associated with a logical channel serving XR service and is configured by the network entity to compute the delay information used for generating a DSR.

In an embodiment, the RLC entity computes the delay information for the buffered data, where the RLC entity computes at least one of: delay incurred by a first RLC SDU yet to be processed by the RLC entity, a delay incurred by a first RLC PDU or a RLC PDU segment yet to be allocated with a UL grant for initial transmission, and delay incurred by the first RLC PDU or RLC PDU segment yet to be allocated with a UL grant for retransmission.

In an embodiment, at least one of a PDCP SDUs to be retransmitted and a PDCP Data PDU to be retransmitted is considered for a PDCP data volume computation for a acknowledged mode (AM) Data Radio Bearers (DRBs) for buffered data delay reporting.

Accordingly, the embodiments herein provide a UE. The UE includes a XR service controller coupled with a processor and a memory. The XR service controller is configured to determine and compose a buffered data delay reporting including a delay information field for the XR service. The delay information field is included in a MAC CE. The delay information field is associated with a corresponding buffer data size information field included in the MAC CE, where the MAC CE pertains to the XR service. The XR service controller is configured to send the buffered data delay reporting to a network entity.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### Advantageous Effects of Invention

Aspects of the present disclosure provide an efficient communication methods in a wireless communication system.

### BRIEF DESCRIPTION OF DRAWINGS

The embodiments disclosed herein are illustrated in the accompanying drawings, throughout which like reference letters indicate corresponding parts in the various figures. The embodiments herein will be better understood from the following description with reference to the drawings, in which:

FIG. 1 illustrates a block diagram illustrating a wireless network for handling a buffered data delay reporting for an XR service, according to the embodiments as disclosed herein;

FIG. 2 illustrates a DSR MAC CE to carry delay information and buffer data size contents for the XR service, according to embodiments as disclosed herein;

FIG. 3 illustrates a common MAC CE (e.g., enhanced BSR MAC CE) to carry BSR contents for XR and non-XR services, according to embodiments as disclosed herein;

FIG. 4 illustrates DSR MAC CE wherein for a XR LCG there may be zero, one or more DSR or BSR contents (i.e., delay Amount field (also termed as delay information field or remaining time) and/or Buffer Size field), according to embodiments as disclosed herein;

FIG. 5 illustrates a structure for of Short Delay reporting BSR MAC CE or DSR MAC CE, according to the embodiments as disclosed herein;

FIG. 6 illustrates a structure for of Short Delay reporting BSR MAC CE or DSR MAC CE, according to the embodiments as disclosed herein;

FIG. 7 illustrates a structure for of LONG Delay reporting BSR MAC CE or DSR MAC CE, according to the embodiments as disclosed herein;

FIG. 8 illustrates a structure of enhanced common BSR MAC CE or DSR MAC CE, according to the embodiments as disclosed herein;

FIG. 9 illustrates various hardware components of a UE, according to the embodiments as disclosed herein;

FIG. 10 illustrates a flow chart illustrating a method for handling a buffered data delay reporting for the XR service in the wireless network, according to the embodiments as disclosed herein;

FIG. 11 illustrates a block diagram illustrating a structure of a UE according to an embodiment of the disclosure; and

FIG. 12 illustrates a block diagram illustrating a structure of a base station according to an embodiment of the disclosure.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

The terms “delay information field”, “delay amount field” and “remaining time field” represent the same field and are/can be used interchangeably in the patent disclosure.

The embodiments herein achieve methods and a UE for managing buffered data delay reporting for extended reality in wireless networks. The method includes determining and composing, by a UE, the buffered data delay reporting including a delay information field for the XR service. The delay information field is included in a MAC CE, and the delay information field is associated with a corresponding buffer data size field included in the MAC CE, and the MAC CE pertains to the XR service. Further, the method includes sending, by the UE, the buffered data delay reporting to a network entity. Also, in an embodiment, the method includes scheduling by the network entity for the different buffered data for the UE based on the corresponding delay information reported. The proposed method can be used for providing an efficient buffered data delay reporting for extended reality in the wireless networks with improved user experience.

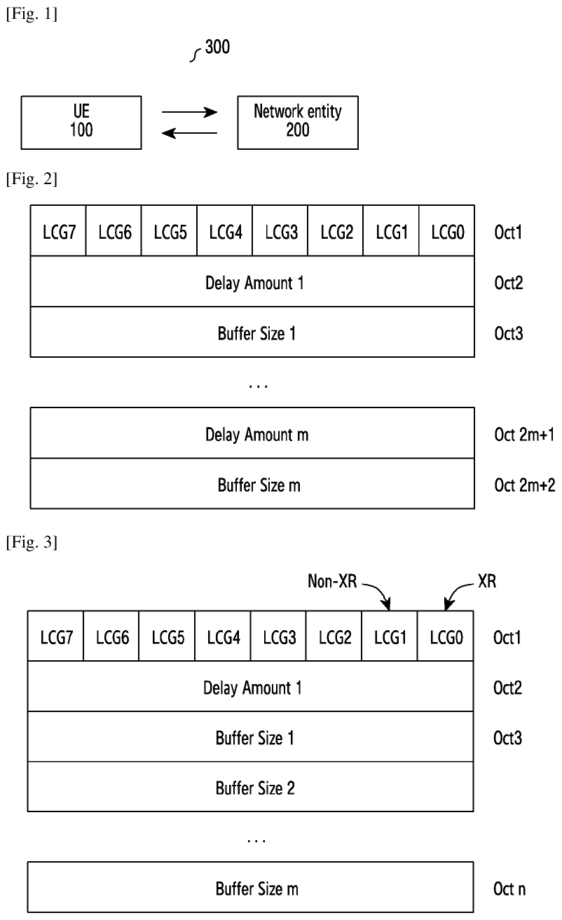

Referring now to the drawings, and more particularly to FIGS. 1 through 10, where similar reference characters denote corresponding features consistently throughout the figures, there are shown at least one embodiment.

FIG. 1 is a block diagram illustrating a wireless network (300) for handling a buffered data delay reporting for an XR service, according to the embodiments as disclosed herein. In an embodiment, the wireless network (300) includes a UE (100) and the network entity (200). The wireless network (300) can be, for example, but not limited to a fourth generation (4G) network, a fifth generation (5G) network, a 6G network, an Open Radio Access Network (ORAN) or the like.

The UE (100) can be, for example, but not limited to a laptop, a smart phone, a desktop computer, a notebook, a Device-to-Device (D2D) device, a vehicle to everything (V2X) device, a foldable phone, a smart TV, a tablet, an immersive device, and an internet of things (IoT) device. The network entity (200) can be, for example, but not limited to a gNB, a eNB, a new radio (NR) trans-receiver or the like.

The UE (100) determines and configures a buffered data delay reporting including a delay information field for the XR service. The delay information field is included in a MAC CE. The delay information field is associated with a corresponding buffer data size field included in the MAC CE, where the MAC CE pertains to the XR service. Further, the UE (100) sends the buffered data delay reporting to the network entity (200).

In an embodiment, one or more delay information (i.e., one or more instances or fields that carry delay information, for simplicity, this may be further referred to herein as also as “one or more delay information” herein) is included in the MAC CE, (termed as a DSR MAC CE or an enhanced BSR MAC CE or a new MAC CE). Each delay information may be associated to a corresponding buffer data size field. The DSR MAC CE, therefore, may include of at least one of buffer data size information field and delay information field for the buffered data.

In an embodiment, the delay information field for the buffered data corresponds to a LCG which may be a group of Logical Channels (LCs). Further, the LCG in the DSR MAC CE or the DSR MAC CE entirely may pertain to the XR services. Further, there may be one or more delay information field for each LCG included in the MAC CE. Further, each delay information field may correspond to the buffer data size field included for the LCG in the DSR MAC CE and each of these buffer data size field may also be included along with the delay information field (e.g., together, one-after-other or in same order to provide a clear mapping between delay information and buffer data size in the DSR MAC CE to the receiving entity).

In an embodiment, when more than one delay information fields are included for the buffered data, they may be arranged in either ascending order or descending order of their delay values. This may be for multiple delay information fields for a single LCG or multiple delay information fields for multiple LCGs. Alternatively, multiple delay information fields for multiple LCGs may be arranged in the priority order of the LCGs.

In an embodiment, the delay information for the buffered data may be at least one of the delay already experienced by the data since it was buffered (e.g., data buffered in the RLC storage and/or in the PDCP storage, where a RLC storage and/PDCP storage may also be commonly referred to as L2 buffer) or the further delay which the buffered data may withstand or allowed as per configuration or performance requirement perspective (e.g., remaining duration for the Packet delay budget (PDB) or PDU Set delay budget (PSDB) or remaining time for the pertinent discard timer expiry).

In an embodiment, the delay information for the buffered data is quantized in at least one of uniform or non-uniform steps to derive mapping indices that represent the value or the range of values for the delay. For example, at least one static or semi-static table (e.g., delay table for XR and/or enhanced BSR table for XR) with different values or ranges of values of delay can be specified by the standards or different values or ranges of values of delay can be determined by specified/configured formulation or different values or ranges of values of delay can be configured by signaling by the network entity (200). The index to the table entry can then represent the value or range of values for delay and can be utilized to be signaled in the delay information field. Alternatively, the delay information could be expressed as a percentage or a fraction of the relevant packet delay budget or PDU Set delay budget for the XR applications (or logical channels or logical channel groups).

FIG. 2 illustrates a DSR MAC CE to carry delay information and buffer data size contents for the XR service, according to embodiments as disclosed herein.

In an embodiment, the new MAC CE (e.g., DSR MAC CE, enhanced BSR MAC CE) can be used to carry only DSR or BSR for XR services (or LCs or LCGs). The new MAC CE for XR services is identified and distinguished from legacy BSR MAC CE for non-XR services by one or more new Logical Channel Identity (LCID). In an embodiment, the new MAC CE for the XR services is identified and distinguished from the legacy BSR MAC CE for the non-XR services by one or more new extended Logical Channel Identity (eLCID). In an embodiment, the eLCID for identifying new MAC CE for XR service is one octet in size. In an embodiment, the eLCID for identifying new MAC CE for XR service is two octets in size. Further, the new MAC CE can be a short BSR, a long BSR or a truncated BSR for XR services and have corresponding new LCIDs, whereas, in an embodiment, the legacy BSR MAC CE is used to carry BSR for non-XR services (or LCs or LCGs). This is illustrated in FIG. 2, which depicts a DSR MAC CE or XR BSR MAC CE format for carrying at least one Delay Amount field (also termed as delay information field) and one Buffer Size field for the corresponding LCGs configured for XR services. The size of the DSR MAC CE or XR BSR MAC CE can be a variable size (e.g., for Long BSR or Long truncated BSR format) and a fixed size (e.g., for Short BSR or Short truncated BSR format). The LCGx (where x is equal to 0 or greater than 0) represents a bit which when set to 1 implies DSR or BSR contents (i.e., delay Amount field and/or Buffer Size field) is present for LCGx and when set to 0 implies DSR or BSR contents (i.e., delay Amount field and Buffer Size field) is not present for LCGx.

FIG. 3 illustrates a common MAC CE (e.g., enhanced BSR MAC CE) to carry BSR contents for XR and non-XR services, according to embodiments as disclosed herein.

In an embodiment, a common MAC CE (e.g., enhanced BSR MAC CE) can be used to carry BSR contents for the XR services and the non-XR services. That is, the MAC CE may include information for the LCGs, where the BSR contents for the XR may include of at least one of buffer data size field and delay information field and include information for LCGs wherein BSR contents for non-XR services may include of buffer data size field. The buffer data size field, its interpretation and corresponding tables for data size may vary for XR and non-XR services. This is illustrated in FIG. 3, which depicts the DSR MAC CE or enhanced BSR MAC CE format for carrying at least one Delay Amount field (also termed as delay information field) and one Buffer Size field for the corresponding LCGs configured for XR services and for carrying at least one Buffer Size field for the corresponding LCGs configured for non-XR services. The size of the DSR MAC CE or enhanced BSR MAC CE can be a variable size (e.g., for Long BSR or Long truncated BSR format) and a fixed size (e.g., for Short BSR or Short truncated BSR format). The Buffer Size field may refer to different tables for the buffered data for a XR LCG and non-XR LCG. That is, composing and interpretation for the Buffer Size field for the XR LCGs and non-XR LCGs may differ. The LCGx (where x is equal to 0 or greater than 0) represents a bit which when set to 1 implies BSR contents (i.e., delay Amount field and/or Buffer Size field) is present for LCGx and when set to 0 implies BSR contents (i.e., delay Amount field and Buffer Size field) is not present for LCGx.

In an embodiment, the delay information field is optional in the DSR or BSR contents. In an embodiment, the separate field including of the single bit (e.g. delayPresence) is used to indicate the presence or absence of the delay information field for the logical channel group in the DSR or BSR contents. If the value of field delayPresence is one (i.e. set) for the logical channel group, the delay amount field is available for the logical channel group in the DSR or BSR contents and if the value of field delayPresence is zero (i.e. reset) for a logical channel group, the delay information field is not available for the logical channel group in the DSR or BSR contents. In an embodiment, if the field delayPresence is zero (i.e. reset) for a logical channel group, the delay information field is available for the logical channel group in the DSR or BSR contents and if the delayPresence is one (i.e. set) for a logical channel group, the delay information field is not available for the logical channel group in the DSR or BSR contents. In an embodiment, the UE (100) includes a field in the DSR or BSR which informs the network entity (200) the number of logical channel groups for which delayPresence is available. In an embodiment, the logical channel groups which has delay information and the information pertaining to the logical channels with delay information are included in the DSR or BSR before including the logical channel groups without delay information.

In an embodiment, the buffer status and the delay information are included in the order of the priority of the logical channel groups.

In an embodiment, if there are not enough UL resources available for sending both buffer status and delay information in the DSR or BSR for the logical channel group, the UE (100) includes only the buffer status, provided there is UL resources available for sending the buffer status.

In an embodiment, if there are not enough UL resources available for sending both buffer status and delay information in the DSR or (enhanced) BSR for the logical channel group, the UE (100) includes only the delay information, if there is UL resources available for sending the delay information for this logical channel group in the DSR or BSR.

In an embodiment, if there are not enough UL resources available for sending both buffer status and delay information in the DSR or (enhanced) BSR for the logical channel group, the UE (100) skips including both buffer status and the delay information, for this logical channel group in the DSR or BSR even if there are UL resources for sending one of delay information or buffer status. In an embodiment, the UE (100) skips sending DSR or BSR in this case.

In an embodiment, if there are not enough UL resources available for sending both buffer status and delay information in the DSR or enhanced BSR or XR BSR for all logical channel groups that have accumulated/buffered data, the UE (100) includes at least one of the buffer status and the delay information for the logical channel groups in the DSR or BSR in their priority order as long as UL resources last.

In an embodiment, the delay information is reported per logical channel instead of logical channel group in the DSR MAC CE or enhanced BSR MAC CE or XR BSR MAC CE. The UE (100) indicates the LCID or eLCID along with the Delay information for that logical channel. In an embodiment, the DSR MAC CE or enhanced BSR MAC CE or XR BSR MAC CE can be configured per logical channel carrying XR service.

In an embodiment, for Regular and Periodic BSR, the MAC entity for which logicalChannelGroup for XR is configured by upper layers shall:
1> if more than one LCG has data available for transmission when the MAC PDU containing the BSR is to be built:
2> report XR Long BSR (or Enahnced Long BSR) for all LCGs which have data available for transmission.
1> else:
2> report XR short BSR (or Enhanced Short BSR).

In an embodiment, for Padding BSR, the MAC entity for which logicalChannelGroup for XR is configured by upper layers shall:
1> if the number of padding bits is equal to or larger than the size of the Short BSR plus its subheader but smaller than the size of the Long BSR plus its subheader:
2> if more than one LCG has data available for transmission when the BSR is to be built:
3> if the number of padding bits is equal to the size of the Short BSR plus its subheader:
4> report XR Short Truncated BSR (or Enhanced Short Truncated BSR). of the LCG with the highest priority logical channel with data available for transmission.
3> else:
4> report XR Long Truncated BSR (or Enhanced Long Truncated BSR). of the LCG(s) with the logical channels having data available for transmission following a decreasing order of the highest priority logical channel (with or without data available for transmission) in each of these LCG(s), and in case of equal priority, in increasing order of LCGID.
2> else:
3> report XR Short BSR (or Enhanced Short BSR).
1> else if the number of padding bits is equal to or larger than the size of the Long BSR plus its subheader:
2> report XR Long BSR (or Enhanced Long BSR). for all LCGs which have data available for transmission.

In an embodiment, at least one of XR Short BSR, XR Long BSR, XR Short Truncated BSR, XR Long Truncated BSR Enhanced Short BSR, Enhanced Long BSR, Enhanced Short Truncated BSR and Enhanced Long Truncated BSR are identified and distinguished with a separate LCID and/or eLCID.

In an embodiment, a sample depiction of the ASN structure containing the configuration for XR BSR or enhanced BSR is shown below:

| xr-BSR-Config-r18 ::= | SEQUENCE { | |
|---|---|---|
| xr-periodicBSR-Timer | | ENUMERATED { sf1, sf5, |

sf10, sf16, sf20, sf32, sf40, sf64,

sf80, sf128,

sf160, sf320, sf640, sf1280, sf2560, infinity },

| | |
|---|---|
| xr-retxBSR-Timer | ENUMERATED { sf10, sf20, |

sf40, sf80, sf160, sf320, sf640, sf1280, sf2560,

| | sf5120, sf10240, |
|---|---|
| spare5, spare4, spare3, spare2, spare1}, | |

| | |
|---|---|
| xr-logicalChannelSR-DelayTimer | ENUMERATED { sf20, |

sf40, sf64, sf128, sf512, sf1024, sf2560, spare1}

| OPTIONAL, -- Need R | |
|---|---|
| xr-BSRTriggerThreshold | INTEGER (0..max-XR-DiscardThreshold) |
| OPTIONAL, | |

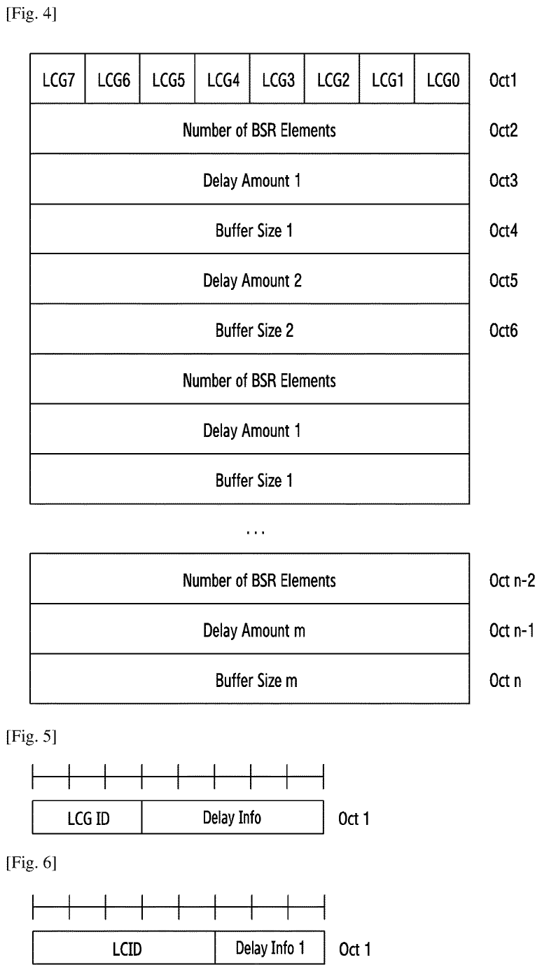

FIG. 4 illustrates DSR MAC CE wherein for a XR LCG there may be zero, one or more DSR or BSR contents (i.e., delay Amount field (also termed as delay information field or remaining time) and/or Buffer Size field), according to embodiments as disclosed herein.

More specifically, FIG. 4 depicts an DSR MAC CE or XR BSR MAC CE wherein for a XR LCG there may be zero, one or more DSR or BSR contents (i.e., delay Amount field (also termed as delay information field) and/or Buffer Size field). The LCGx (where x is equal to 0 or greater than 0) represents a bit which when set to 1 implies one or more BSR contents (i.e., delay Amount field and/or Buffer Size field) is present for LCGx and when set to 0 implies DSR or BSR contents (i.e., delay Amount field and Buffer Size field) is not present for LCGx. The number of DSR/BSR elements field denotes the number of DSR/BSR contents for the pertinent LCG follows in the MAC CE.

In an embodiment, the delay information field can carry a zero or a special reserved value that can be interpreted by the network entity (200) that the data corresponding to buffer data size field has been discarded by the UE (100).

In an embodiment, the delay information field can carry a zero or a special reserved value that can be interpreted by the network entity (200) that the data corresponding to buffer data size field is not delay critical.

In an embodiment, the delay information field is not present, and absence of delay information field can be interpreted by the network entity (200) that the data corresponding to buffer data size field is not delay critical.

In an embodiment, the delay information field can carry a zero or a special reserved value that can be interpreted by the network entity (200) that the data corresponding to buffer data size field has been buffered recently and delay information is considered to be as remaining duration same as PDB or PSDB.

In an embodiment, the delay information field is not present, and absence of delay information field can be interpreted by the network entity (200) that the data corresponding to buffer data size field has been buffered recently and delay information is considered to be as remaining duration same as PDB or PSDB.

In an embodiment, the delay information field is carried in the BSR using a single bit. The single bit indicates that the data in the logical channel group is delay critical. In an embodiment, the delay information field is carried in the DSR or BSR UL MAC CE using two bits which includes a quantized value for the delay or actual delay (or permissible delay etc. as per other embodiments).

In an embodiment, the delay information field is carried in the DSR or BSR UL MAC CE using three bits which includes a quantized value for the delay or actual delay (or permissible delay etc. as per other embodiments). In an embodiment, the delay information field is carried in the DSR or BSR UL MAC CE using four bits which includes a quantized value for the delay or actual delay (or permissible delay etc. as per other embodiments). In an embodiment, the delay information field is carried in the DSR or BSR UL MAC CE using five bits which includes a quantized value for the delay or actual delay (or permissible delay etc. as per other embodiments). In an embodiment, the delay information field is carried in the DSR or BSR UL MAC CE using six bits which includes a quantized value for the delay or actual delay (or permissible delay etc. as per other embodiments). In an embodiment, the delay information field is carried in the DSR or BSR UL MAC CE using seven bits which includes a quantized value for the delay or actual delay (or permissible delay etc. as per other embodiments). In an embodiment, the delay information field is carried in the DSR or BSR UL MAC CE using eight bits which includes a quantized value for the delay or actual delay (or permissible delay etc. as per other embodiments).

In an embodiment, the UE (100) includes delay information field only for one or more specific logical channel groups configured by the network entity (200) for sending delay information field. In an embodiment, the configuration is received from the network (for e.g. gNB) in RRC message such as RRC Reconfiguration or RRC Resume.

In an embodiment, the DSR MAC CE or enhanced BSR MAC CE is triggered when at least one of the following event is met:
a. Discard timer(s) for the X number of SDU(s) or PDU Set(s) expires, where X can be an integer equal to 1 or greater than 1. X can be configured by network signaling.
b. Loss of Y number of SDU(s) or PDU Set (s), where Y can be an integer equal to 1 or greater than 1. Y can be configured by the network signaling.
c. Uplink data, for a logical channel which belongs to an LCG for XR services, becomes available to the MAC entity and either this uplink data belongs to a logical channel with a higher priority than the priority of any logical channel containing available uplink data which belong to any LCG or none of the logical channels which belong to an LCG contains any available uplink data.
d. Uplink data, for a logical channel which belongs to an LCG for XR services, becomes unavailable (e.g., due to discard at PDCP) to the MAC entity and either this uplink data belongs to a logical channel with a higher priority than the priority of any logical channel containing available uplink data which belong to any LCG or none of the logical channels which belong to an LCG contains any available uplink data.
e. retxBSR-Timer expires, and at least one of the logical channels which belong to an LCG for XR services contains UL data.
f. XR-retxBSR-Timer expires, and at least one of the logical channels which belong to an LCG for XR services contains UL data.
g. periodicBSR-Timer expires, and the MAC entity is serving the XR services.
h. XR-periodicBSR-Timer expires, and the MAC entity is serving the XR services.
i. the delay of the packet or PDU or PDU set or SDU meets a threshold. In an embodiment, the threshold is provided by the network in RRC signalling. In an embodiment, the threshold is configured per logical channel. In an embodiment, the threshold is configured per logical channel group. In an embodiment, the threshold is configured per PDU set. In an embodiment, the threshold is configured within the UE (100), based on standards or algorithms.

In an embodiment, the DSR MAC CE or enhanced BSR MAC CE is triggered when the UE (100) is configured by the network entity (200) to trigger the DSR MAC CE or the enhanced BSR MAC CE. In an embodiment, the DSR MAC CE or enhanced BSR MAC CE is triggered only when there are events for one or more specific logical channel groups configured by the network entity (200) for sending DSR MAC CE or enhanced BSR MAC CE. In an embodiment, the configuration is received from the network entity (200) (for e.g. gNB) in RRC message such as RRC Reconfiguration or RRC Resume.

In an embodiment, the UE (100) informs the network entity (200) whether it is capable for delay information reporting. In an embodiment this information is sent in the RRC procedures for UE (100) capability information retrieval. In an embodiment, the capability is UE (100) AS capability. In an embodiment, a common capability for the XR is used for delay information reporting.

In an embodiment, a scheduling request is triggered when the regular BSR is triggered for at least one logical channel (e.g., for XR service) irrespective of whether logicalChannelSR-DelayTimer is running or not. This provides for a faster SR triggering for XR. The example specification text is given as below:

The MAC entity shall:
1> if the Buffer Status reporting procedure determines that at least one BSR has been triggered and not cancelled:
2> if UL-SCH resources are available for a new transmission and the UL-SCH resources can accommodate the BSR MAC CE plus its subheader as a result of logical channel prioritization:
3> instruct the Multiplexing and Assembly procedure to generate the BSR MAC CE(s) as defined in clause 6.1.3.1;
3> start or restart periodicBSR-Timer except when all the generated BSRs are long or short Truncated or Extended long or short Truncated BSRs;
3> start or restart retxBSR-Timer.
2> if a Regular BSR has been triggered for a logical channel for which logicalChannelSR-DelayTimerApplied with value true is configured by upper layers and logicalChannelSR-DelayTimer is not running: or
2> if a Regular BSR has been triggered for a logical channel for which logicalChannelSR-DelayTimerApplied with value false is configured by upper layers (e.g., for XR service):
3> if there is no UL-SCH resource available for a new transmission; or
3> if the MAC entity is configured with configured uplink grant(s) and the Regular BSR was triggered for a logical channel for which logicalChannelSR-Mask is set to false; or
3> if the UL-SCH resources available for a new transmission do not meet the LCP mapping restrictions (see clause 5.4.3.1) configured for the logical channel that triggered the BSR:
4> trigger a Scheduling Request.

In an embodiment, the scheduling request is triggered when the regular BSR is triggered for at least one logical channel for XR service. This is termed as ‘DSR’ or ‘BSR for XR’ or ‘XR BSR’ and corresponding MAC CE is termed as ‘DSR MAC CE’ or ‘XR BSR MAC CE’. DSR MAC CE or XR BSR MAC CE may include at least one of the delay information field and buffer data size field for one or more LCGs. These LCGs pertain to and are configured for XR. The example specification text is given as below:

The MAC entity shall:
1> if the Buffer Status reporting procedure determines that at least one XR BSR has been triggered and not cancelled:
2> if UL-SCH resources are available for a new transmission and the UL-SCH resources can accommodate the XR BSR MAC CE plus its subheader as a result of logical channel prioritization:
3> instruct the Multiplexing and Assembly procedure to generate the XR BSR MAC CE(s);
3> start or restart periodicBSR-Timer (or XR-periodicBSR-Timer) except when all the generated BSRs are long or short Truncated or Extended long or short Truncated BSRs;
3> start or restart retxBSR-Timer (or XR-retxBSR-Timer).
2> if a Regular BSR has been triggered and logicalChannelSR-DelayTimer is not running:
3> if there is no UL-SCH resource available for a new transmission; or
3> if the MAC entity is configured with configured uplink grant(s) and the Regular BSR was triggered for a logical channel for which logicalChannelSR-Mask is set to false; or
3> if the UL-SCH resources available for a new transmission do not meet the LCP mapping restrictions (see clause 5.4.3.1) configured for the logical channel that triggered the XR BSR:
4> trigger a Scheduling Request.

In an embodiment, a MAC PDU contains at most one DSR MAC CE or one BSR MAC CE or one enhanced BSR MAC CE, when multiple events have triggered a DSR or BSR, and BSR is commonly signaled as a common MAC CE for XR and non-XR services.

In an embodiment, a MAC PDU contains at most one BSR MAC CE and/or at most one XR BSR MAC CE, when multiple events have triggered a DSR or BSR and/or a XR BSR, and the BSR is separately signaled as different MAC CEs for XR and non-XR services (i.e. XR BSR MAC CE and BSR MAC CE).

In an embodiment, if a HARQ process is configured with cg-RetransmissionTimer and if the DSR or BSR is already included in a MAC PDU for transmission on configured grant by this HARQ process, but not yet transmitted by lower layers, then the UE (100) updates the DSR or BSR contents (e.g., DSR MAC CE or enhanced BSR MAC CE or XR BSR MAC CE) with the latest delay information and/or the buffered data status.

In an embodiment, for BSR triggered by retxBSR-Timer expiry, the MAC entity considers that the logical channel that triggered the BSR is the highest priority logical channel that has data available for transmission at the time the BSR is triggered, except when the data becomes unavailable e.g., due to packet discard or packet loss or exceeding delay limit. In this case, at least one of the following is performed: the BSR is cancelled or the BSR with zero buffer data size is reported.

In an embodiment, at least one triggered DSR or BSR may be cancelled when data (e.g., for XR service) becomes unavailable due to SDU or PDU Set discard upon discard timer expiry or loss of packets.

In an embodiment, at least one triggered DSR or BSR may not be cancelled when data (e.g., for XR service) becomes unavailable due to SDU or PDU Set discard upon discard timer expiry or loss of packets. BSR is signaled to the network entity (200) in this case to inform the update of buffer status (i.e., becoming empty). DSR or BSR therefore may be a zero DSR or BSR i.e., carrying the buffer data size field as zero.

In an embodiment, at least one DSR or BSR triggered priori to MAC PDU assembly may be cancelled when a MAC PDU is transmitted. This PDU includes a Long, Extended Long, Short, or Extended Short BSR MAC CE, Enhanced Short BSR MAC CE, Enhanced Long BSR MAC CE which contains buffer status up to (and including) the last event that triggered a BSR prior to the MAC PDU assembly.

In an embodiment, LCGs and/or LCs for XR and non-XR services are distinguished based on the configuration. For example, RRC reconfiguration message carrying configuration for bearer and logical channel carry at least a field that signifies which LCG and/or LC is XR related or non-XR related.

FIG. 5 illustrates a structure for of short delay reporting BSR MAC CE or DSR MAC CE carrying the (average and/or least) 5-bit delay information of PDU set/PDU in that LCG.

FIG. 6 illustrates a structure for of short delay reporting BSR MAC CE or DSR MAC CE carrying the (average and/or least) 3-bit delay information of PDU set/PDU in that LCID.

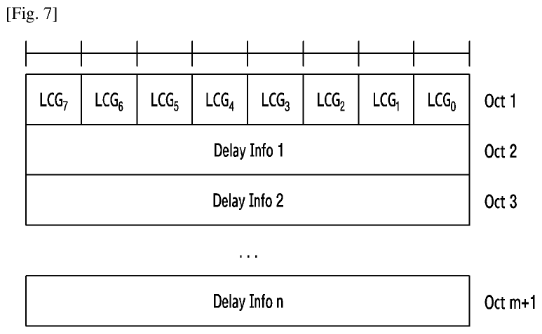

FIG. 7 illustrates a structure for of long delay reporting BSR MAC CE or DSR MAC CE carrying the (average and/or least) 8-bit delay information of PDU set/PDU in that LCG.

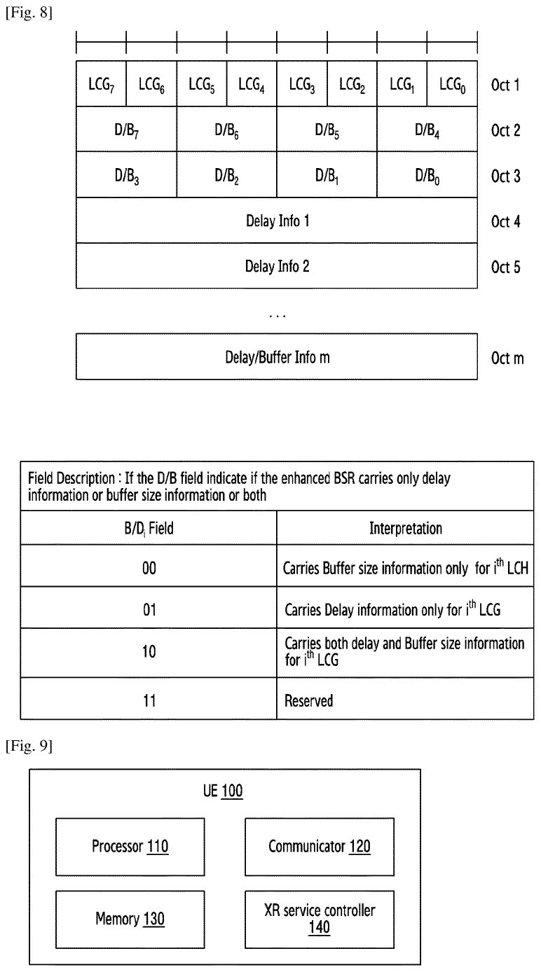

FIG. 8 illustrates a structure of enhanced common BSR MAC CE or DSR MAC CE carrying the (average and/or least) delay information or buffer status.

In an embodiment, when the enhanced BSR MAC CE or the XR BSR MAC CE included in the message 1 (msg1) or message 3 (msg3) in the random access procedure and there is retransmission of msg1 or msg3, the DSR MAC CE or enhanced BSR MAC CE or XR BSR MAC CE may be included with updating the DSR or BSR contents (e.g. delay information and/or buffer data size).

In an embodiment, the PDCP entity associated with an XR Radio bearer and/or PDCP entity configured by the network entity (200) to calculate the delay information, calculates the delay information used for generation of DSR or XR BSR or enhanced BSR for delay reporting. The PDCP entity may calculate one or more delay information for the buffered data. The transmitting entity of the PDCP calculates one or combination of the following delay information:
a. Delay calculated as time elapsed since reception of the first PDCP SDU in the buffer yet to be processed by PDCP entity;
b. Remaining time in delay budget associated with the first PDCP SDU in the buffer yet to be processed by the PDCP entity;
c. Remaining delay budget associated with the PDU Set to which first PDCP SDU in the buffer belongs to and is yet to be processed by the PDCP entity;
d. Average delay associated with the PDCP SDUs yet to be processed by the PDCP entity; and
e. Average Delay associated with the PDCP PDUs yet to be submitted to lower layers.

In an embodiment, the PDCP entity indicates the at least one of or combination of the calculated value to MAC entity for delay BSR,
a. the average delay of the PDCP SDUs in the buffer, and/or
b. the average remaining delay budget for the PDCP SDUs/PDUs in the buffer, and/or
c. the delay associated with the PDCP SDU/PDU which has the maximum delay among the SDUs in the buffer, and/or
d. the minimum remaining delay budget for the SDUs/PDUs in the buffer.

In an embodiment, the RLC entity associated with a logical channel serving XR service and/or is configured by the network entity (200) to calculates the delay information used for generating the DSR or XR BSR or enhanced BSR. The RLC entity may calculate one or more delay information for the buffered data. The transmitting RLC entity computes one or combination of the following:
1. Delay incurred by the first RLC SDU yet to be processed by the RLC entity,
2. Delay incurred by the first RLC PDU or RLC PDU segment yet to be allocated with a UL grant for initial transmission,
3. Delay incurred by the first RLC PDU or RLC PDU segment yet to be allocated with a UL grant for retransmission,
4. Average delay incurred by the RLC SDUs in the buffer yet to be processed by the RLC entity,
5. Average delay incurred by the RLC PDU or RLC PDU segments in buffer yet to be allocated with a UL grant for initial transmission, and
6. Average delay incurred by the RLC PDUs or RLC PDU segments in buffer yet to be allocated with a UL grant for retransmission.

In another embodiment, the network entity (200) configures the UE (100) on which of the delay quantities the PDCP/RLC entities has to measure as part of
1. Radio bearer configuration, and/or
2. Logical channel Configuration, and/or
3. BSR configuration, and/or
4. XR specific BSR configuration for delay reporting.

In an embodiment, data volume calculation for the purpose DSR or XR BSR or enhanced BSR is performed at the transmitting PDCP entity to determine PDCP data volume and at the transmitting RLC entity to determine RLC data volume. The PDCP data volume and/or RLC data volume may be categorized to one or more delay values or range of delay values e.g. one or more range of delay values formed as between x percent and y percent or fraction of the packet delay budget or PDU Set delay budget. For example, four ranges can be: (a) less than 25%, (b) 25% to less than 50%, (c) 50% to less than 75% and (d) 75% to 100% of PDB or PSDB. Data volume thus can be accounted under respective range of delays based on the delay encountered since the SDU/PDU/PDU Set or PDU Sets is buffered at PDCP buffer. The PDPC entity provides the delay information to the RLC entity when the SDU/PDU/PDU Set is passed to the RLC entity, so that RLC entity can start from this given value of the delay and account for further delay in the RLC buffer. The PDCP entity and/or RLC entity indicate the calculated data volume and the pertinent delay values or range of delay values to the MAC entity e.g. when the MAC entity needs to compose and send the DSR MAC CE or XR BSR MAC CE or enhanced BSR MAC CE. In an alternative embodiment, delay value or range of delay values can be the remaining duration to the expiry of the pertinent discard timer or completion of the PDB or PSDB.

In an embodiment, for the PDCP data volume calculation for the acknowledged mode (AM) Data Radio Bearers (DRBs), the PDCP SDUs to be retransmitted and/or the PDCP Data PDUs to be retransmitted may also be considered. For these data volume calculation, the delay value or the range of delay values are accounted from the time when these data were buffered in the PDCP buffer from the application for the first transmission.

In an embodiment, in case of PDCP duplication with activated state, same delay amount (also termed as delay information or remaining time) is considered while calculating the PDCP data volume for both the MAC entities associated with primary RLC entity and the RLC entity other primary RLC entity.

In an embodiment, for the RLC data volume calculation for the acknowledged mode (AM) Data Radio Bearers (DRBs), the RLC data PDUs that are pending for retransmission may also be considered. For these data volume calculation, the delay value or the range of delay values are accounted from the time when these data were buffered in the PDCP buffer from the application for the first transmission.

FIG. 9 illustrates various hardware components of the UE (100), according to the embodiments as disclosed herein. In an embodiment, the UE (100) includes a processor (110), a communicator (120), a memory (130) and a XR service controller (140). The processor (110) is coupled with the communicator (120), the memory (130) and the XR service controller (140).

The XR service controller (140) determines and configures the buffered data delay reporting including the delay information field for the XR service. The delay information field is included in the MAC CE (termed as DSR MAC CE). The delay information field is associated with the corresponding buffer data size information included in the MAC CE. The MAC CE pertains to the XR service. The XR service controller (140) sends the buffered data delay reporting to the network entity (200).

The XR service controller (140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (110) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (110) may include multiple cores and is configured to execute the instructions stored in the memory (130).

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

In an embodiment, the communicator (120) includes an electronic circuit specific to a standard that enables wired or wireless communication. The communicator (120) is configured to communicate internally between internal hardware components of the UE (100) and with external devices via one or more networks.

Although the FIG. 9 shows various hardware components of the UE (100) but it is to be understood that other embodiments are not limited thereon. In other embodiments, the UE (100) may include less or more number of components. Further, the labels or names of the components are used only for illustrative purpose and does not limit the scope of the invention. One or more components can be combined together to perform same or substantially similar function in the UE (100).

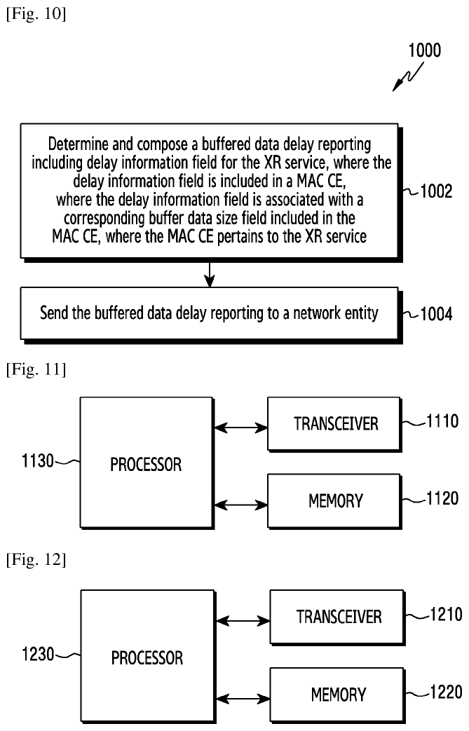

FIG. 10 is a flow chart (1000) illustrating a method for handling a buffered data delay reporting for an extended reality (XR) service in the wireless network (300), according to the embodiments as disclosed herein. The operations (1002-1004) are handled by the XR service controller (140).

At 1002, the method includes determining and composing the buffered data delay reporting including the delay information field for the XR service. The delay information field is included in the MAC CE (termed as DSR MAC CE), and the delay information field is associated with the corresponding buffer data size field included in the MAC CE, and the MAC CE pertains to the XR service. At 1004, the method includes sending the buffered data delay reporting to the network entity (200).

The various actions, acts, blocks, steps, or the like in the flow charts (1000) may be performed in the order presented, in a different order or simultaneously. Further, in some embodiments, some of the actions, acts, blocks, steps, or the like may be omitted, added, modified, skipped, or the like without departing from the scope of the invention.

FIG. 11 illustrates a block diagram illustrating a structure of a UE according to an embodiment of the disclosure. FIG. 11 corresponds to the example of the UE of FIG. 9.

As shown in FIG. 11, the UE according to an embodiment may include a transceiver 1110, a memory 1120, and a processor (or a controller) 1130. The transceiver 1110, the memory 1120, and the processor 1130 of the UE may operate according to a communication method of the UE described above. However, the components of the UE are not limited thereto. For example, the UE may include more or fewer components than those described above. In addition, the processor 1130, the transceiver 1110, and the memory 1120 may be implemented as a single chip. Also, the processor 1130 may include at least one processor or at least one controller.

The transceiver 1110 collectively refers to a UE receiver and a UE transmitter, and may transmit/receive a signal to/from a base station or a network entity. The signal transmitted or received to or from the base station or a network entity may include control information and data. The transceiver 1110 may include a RF transmitter for up-converting and amplifying a frequency of a transmitted signal, and a RF receiver for amplifying low-noise and down-converting a frequency of a received signal. However, this is only an example of the transceiver 1110 and components of the transceiver 1110 are not limited to the RF transmitter and the RF receiver.

Also, the transceiver 1110 may receive and output, to the processor 1130, a signal through a wireless channel, and transmit a signal output from the processor 1130 through the wireless channel.

The memory 1120 may store a program and data required for operations of the UE. Also, the memory 1120 may store control information or data included in a signal obtained by the UE. The memory 1120 may be a storage medium, such as read-only memory (ROM), random access memory (RAM), a hard disk, a CD-ROM, and a DVD, or a combination of storage media.

The processor 1130 may control a series of processes such that the UE operates as described above. For example, the transceiver 1110 may receive a data signal including a control signal transmitted by the base station or the network entity, and the processor 1130 may determine a result of receiving the control signal and the data signal transmitted by the base station or the network entity.

FIG. 12 illustrates a block diagram illustrating a structure of a base station according to an embodiment of the disclosure.

As shown in FIG. 12, the base station according to an embodiment may include a transceiver 1210, a memory 1220, and a processor (or a controller) 1230. The transceiver 1210, the memory 1220, and the processor 1230 of the base station may operate according to a communication method of the base station described above. However, the components of the base station are not limited thereto. For example, the base station may include more or fewer components than those described above. In addition, the processor 1230, the transceiver 1210, and the memory 1220 may be implemented as a single chip. Also, the processor 1230 may include at least one processor at least one controller.

The transceiver 1210 collectively refers to a base station receiver and a base station transmitter, and may transmit/receive a signal to/from a terminal or a network entity. The signal transmitted or received to or from the terminal or a network entity may include control information and data. The transceiver 1210 may include a RF transmitter for up-converting and amplifying a frequency of a transmitted signal, and a RF receiver for amplifying low-noise and down-converting a frequency of a received signal. However, this is only an example of the transceiver 1210 and components of the transceiver 1210 are not limited to the RF transmitter and the RF receiver.

Also, the transceiver 1210 may receive and output, to the processor 1230, a signal through a wireless channel, and transmit a signal output from the processor 1230 through the wireless channel.

The memory 1220 may store a program and data required for operations of the base station. Also, the memory 1220 may store control information or data included in a signal obtained by the base station. The memory 1220 may be a storage medium, such as read-only memory (ROM), random access memory (RAM), a hard disk, a CD-ROM, and a DVD, or a combination of storage media.

The processor 1230 may control a series of processes such that the base station operates as described above. For example, the transceiver 1210 may receive a data signal including a control signal transmitted by the terminal, and the processor 1230 may determine a result of receiving the control signal and the data signal transmitted by the terminal.

The embodiments disclosed herein can be implemented through at least one software program running on at least one hardware device and performing network management functions to control the elements. The elements can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

1. A user equipment (UE) in a wireless communication system, the UE comprising:
a transceiver; and
a controller coupled with the transceiver, and configured to:
receive, from a base station via a radio resource control (RRC) signaling, information configuring a threshold for triggering a delay report for a logical channel group (LCG),
identify that the delay report is triggered based on the threshold and a remaining value of a discard timer, and
transmit, to a base station, a medium access control (MAC) control element (CE) associated with the delay report for the LCG.

2. The UE of claim 1,
wherein the MAC CE is generated in case that an uplink-shared channel (UL-SCH) resource is able to accommodate the MAC CE and a subheader for the MAC CE.

3. The UE of claim 1,
wherein the delay report is cancelled, in case that all of a service data unit (SDU) associated with the delay report is discarded, a MAC protocol data unit (PDU) including all of the SDU associated with the delay report is transmitted, or a MAC PDU including at least one MAC CE is transmitted.

4. The UE of claim 1,
wherein the MAC CE includes first information indicating a presence of the delay report for the LCG, second information indicating the remaining value for the LCG, and third information indicating an amount of data for the LCG, and
wherein an extended logical channel identity (eLCID) of the MAC CE indicates that the MAC CE is for the delay report.

5. The UE of claim 4,
wherein the second information indicates the remaining value within a range of values using 6 bits, and
wherein the second information and the third information are included in the MAC CE in ascending order of an LCG index.

6. The UE of claim 1,
wherein a radio link control (RLC) entity of the UE calculates an RLC data volume for the delay report, and the RLC data volume is based on at least one of:
an RLC SDU have not yet been included in an RLC PDU;
an RLC PDU associated with an initial transmission; or
an RLC PDU associated with a retransmission for an acknowledged mode (AM) data radio bearer (DRB).

7. The UE of claim 1,
wherein a packet data convergence protocol (PDCP) entity of the UE calculates a PDCP data volume for the delay report, and the PDCP data volume is based on at least one of:
a PDCP PDU including a PDCP SDU is not transmitted to lower layers;
a PDCP SDU associated with a retransmission for an AM DRB; or
a PDCP PDU associated with the retransmission for the AM DRB.

8. A method performed by a user equipment (UE) in a wireless communication system, the method comprising:
receiving, from a base station via a radio resource control (RRC) signaling, information configuring a threshold for triggering a delay report for a logical channel group (LCG);
identifying that the delay report is triggered based on the threshold and a remaining value of a discard timer; and
transmitting, to a base station, a medium access control (MAC) control element (CE) associated with the delay report for the LCG.

9. The method of claim 8,
wherein the MAC CE is generated in case that an uplink-shared channel (UL-SCH) resource is able to accommodate the MAC CE and a subheader for the MAC CE.

10. The method of claim 8,
wherein the delay report is cancelled, in case that all of a service data unit (SDU) associated with the delay report is discarded, a MAC protocol data unit (PDU) including all of the SDU associated with the delay report is transmitted, or a MAC PDU including at least one MAC CE is transmitted.

11. The method of claim 8,
wherein the MAC CE includes first information indicating a presence of the delay report for the LCG, second information indicating the remaining value for the LCG, and third information indicating an amount of data for the LCG, and
wherein an extended logical channel identity (eLCID) of the MAC CE indicates that the MAC CE is for the delay report.

12. The method of claim 11,
wherein the second information indicates the remaining value within a range of values using 6 bits, and
wherein the second information and the third information are included in the MAC CE in ascending order of an LCG index.

13. The method of claim 8,
wherein a radio link control (RLC) entity of the UE calculates an RLC data volume for the delay report, and the RLC data volume is based on at least one of:
an RLC SDU have not yet been included in an RLC PDU;
an RLC PDU associated with an initial transmission; or
an RLC PDU associated with a retransmission for an acknowledged mode (AM) data radio bearer (DRB).

14. The method of claim 8,
wherein a packet data convergence protocol (PDCP) entity of the UE calculates a PDCP data volume for the delay report, and the PDCP data volume is based on at least one of:
a PDCP PDU including a PDCP SDU is not transmitted to lower layers;
a PDCP SDU associated with a retransmission for an AM DRB; or
a PDCP PDU associated with the retransmission for the AM DRB.
